(19) United States
(12) Patent Application Publication
(10) Pub. No.: US 2002/0130017 A1
(43) Pub. Date: Sep. 19, 2002

(54) Combination cursor key and enter key for hand held electronic devices

(76) Inventors: Robert M. Kalis, Overland Park, KS (US); Kent Broddle, Olathe, KS (US); Larry P. Fotovich, Gardner, KS (US)

Correspondence Address: GARMIN INTERNATIONAL, INC., 1200 East 151st Street, Olathe, KS, 66062, US

(21) Appl. No.: 09/627,994

(22) Filed: Mar. 19, 2001

(51) Int. Cl. H01H 9/00

(52) U.S. Cl. 200/5 R

(57) ABSTRACT

A cursor key having an enter key located at its center for the keypad of a hand held electronic device. The cursor key has up and down and left and right areas depressed by a finger or thumb to move an on-screen cursor. The enter key projects through an opening in the center of the cursor key where it is conveniently located to be pressed immediately following manipulation of the cursor key.

### FIELD OF THE INVENTION

This invention relates generally to electronic devices and particularly hand held devices of the type commonly used in portable communications and in navigation applications. More particularly, the invention is directed to a keypad having a combination cursor key and enter key that are incorporated together for convenient use.

### BACKGROUND OF THE INVENTION

A variety of handheld electronic devices have become popular in recent years. Hand held computers, GPS based navigation aids, and portable telephones and other communication devices are examples of electronic devices that have gained wide popularity. These devices typically include a screen on which various information is displayed and a keypad allowing the device to receive instructions and data and carry out the functions it is designed to perform.

Among the keys that are commonly found on the keypad are a cursor key and an enter key. The cursor key has up and down areas at the top and bottom which scroll a cursor up and down on the screen when pressed with the finger or thumb. Similarly, left and right areas of the cursor key allow the cursor on the display to be scrolled to the left or right until it is moved to the desired location. The enter key is used to enter into the device the information selected by manipulating other keys. It is common for the cursor key to be used and the enter key to be used immediately thereafter to enter what is indicated by the cursor location.

The cursor key can be a joystick device that rocks or tilts when actuated. However, a joystick type key can be overly sensitive and can easily be actuated inadvertently when subjected to vibration or other influences. If vibration is encountered, conventional cursor keys (which move predominantly upward and downwardly, with a slight amount of rocking possible) are more desirable because they are less sensitive and require intentional depression (in one of four directions) with the thumb or finger for actuation.

### SUMMARY OF THE INVENTION

The present invention has as its principal goal the provision of a combination cursor key and enter key that are arranged and located for convenient use of the enter key immediately after the cursor key has been used.

More specifically, it is an object of the invention to provide, in a keypad for a hand held electronic device, an enter key that extends through and is located in the center of a cursor key and yet operates independently of the cursor key. Due to the location of the enter key in the center of the cursor key, it can be quickly and easily actuated following use of the cursor key to enhance the overall convenience of use of the keypad.

Among the other objects of the invention are to provide a combination cursor and enter key that result in a low overall keypad cost, is compatible with prevailing keypad designs, is constructed ruggedly and in a weatherproof manner, and is not subject to problems due to vibration or other outside forces.

In accordance with the invention, a hand held electronic device such as a GPS based navigation aid or a personal communications device has a visual display and a keypad equipped with a special combination cursor and enter key. Preferably, the cursor key has a circular shape with up and down arrows and left and right arrows indicating placement of the thumb to scroll the on screen cursor to the desired location. The enter key extends through a central opening in the cursor key where it is conveniently located for quick actuation after the cursor key has been used.

The cursor key is preferably a conventional key rather than a joystick type device that rocks or tilts. The keypad may be elastomeric, and a snap dome switch array may be interposed between the keypad and a printed circuit board that is equipped with switch contacts. This construction avoids over sensitivity, provides for a low cost manufacturing operation, and results in a rugged and weatherproof unit.

### DESCRIPTION OF THE DRAWINGS

In the accompanying drawings which form a part of the specification and are to be read in conjunction therewith and in which like reference numerals are used to indicate like parts in the various views:

FIG. 1 is a front elevational view of a hand held electronic device of the type that can be equipped with a combination cursor and enter key constructed in accordance with the present invention;

FIG. 2 is an exploded front perspective view showing the combined cursor and enter key, keypad, snap dome switch array and printed circuit board which may be included in the device shown in FIG. 1 and

FIG. 3 is an exploded rear perspective view showing the same components as FIG. 2.

### DETAILED DESCRIPTION OF THE INVENTION

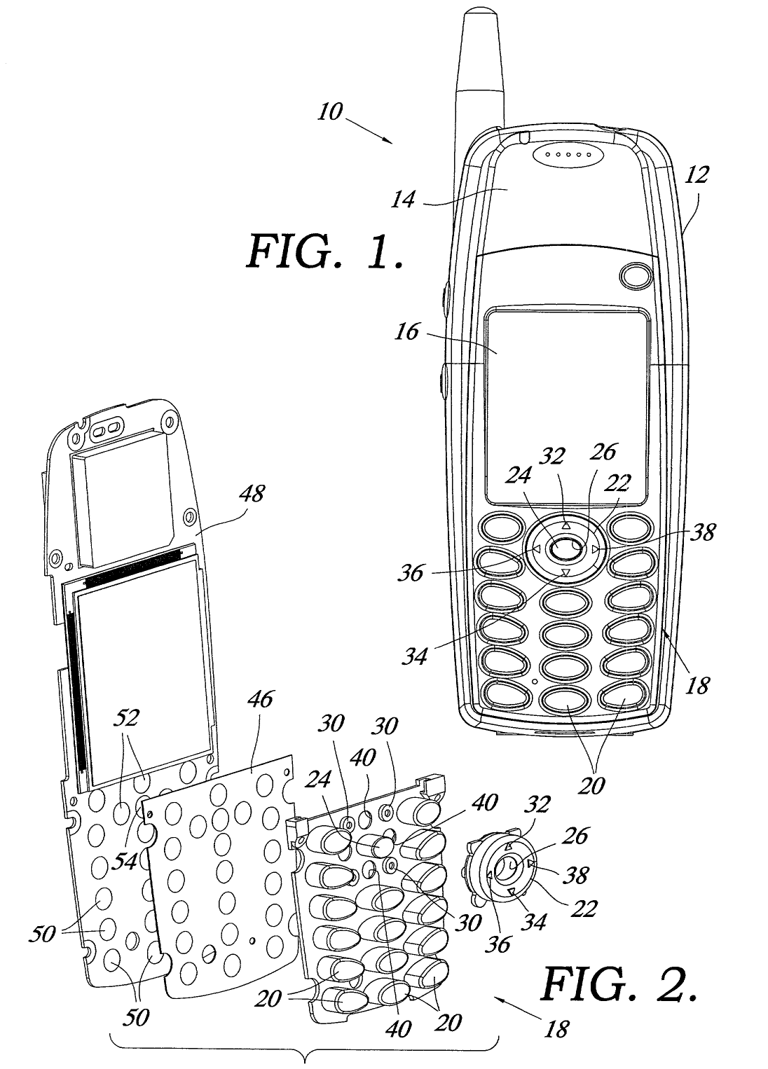

Referring now to the drawings in more detail and initially to FIG. 1, numeral 10 generally designates a hand held electronic device which may be a wireless communications device, a hand held computer, a GPS based navigation device, or another type of hand held unit. The device 10 has a rigid housing or body 12 which houses the electronic components and is small enough to be held in the hand of the user. The body 12 has a front face 14 that is equipped with a screen 16 providing a visual display and a keypad 18 having a plurality of individual keys 20. The keypad 18 may be located immediately below the screen 16. The keys 20 are finger operated keys and may include keys that allow instructions and various data to be input, along with keys that effect various functions the device is designed to perform. The face 14 of the device 10 may be provided with other components and indicators.

In accordance with the present invention, one of the keys on the keypad includes a combination of a cursor key 22 and an enter key 24. The cursor key 22 preferably has a generally round or slightly oval shape and is provided with an opening 26 in its center through which the enter key 24 projects. The combination cursor key 22 and enter key 24 are located at the top of the keypad 18 and are substantially centered across the width of the keypad.

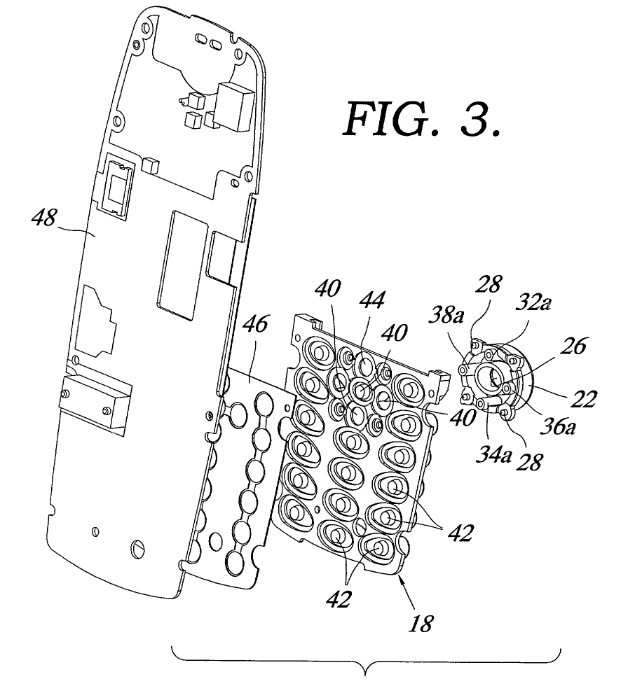

As best shown in FIG. 2, the keypad 18 may be an elastomeric keypad having the keys 22 projecting forwardly from its surface. The enter key 24 likewise projects forwardly from the center of the keypad 18. The cursor key 22 is connected with the keypad 18 through the use of four pin type fasteners 28 (see FIG. 3) that project from the back of key 22 and are received in mating sockets 30 (FIG. 2) formed on the keypad 18 adjacent to and surrounding the enter key 24. The cursor key may also be formed as part of the keypad 18, so long as it is free to move independently of the enter key 24. With reference to FIGS. 1 and 2 in particular, the front face of the cursor key 22 is provided with an up area on its top portion that contains an up arrow 32 which points upwardly. The bottom portion of the front face of switch 22 is provided with a down area that includes a downwardly pointing arrow 34. A left area on the front face of switch 22 contains an arrow 36 that points to the left. Finally, a right area on the face of the cursor key 22 contains an arrow 38 that points to the right. The up arrow 32 is depressed with the thumb or finger in order to scroll a conventional cursor on the screen 16 in an upward direction. Conversely, to scroll the cursor on screen 16 downwardly, the down arrow 34 is depressed. The cursor can be moved to the left by depressing the arrow 36 with the thumb or finger, while arrow 38 can be depressed with the thumb or finger to move the cursor to the right on screen 16.

As shown in FIG. 3, pins 32a, 34a, 36a and 38a project from the backside of the cursor key 22 at locations immediately behind the respective arrows 32, 34, 36 and 38. Pins 32a-38a extend through openings 40 in the keypad 18.

As shown in FIG. 3, the keys 20 have pins 42 projecting rearwardly from the keypad 18. The enter key 24 also has a pin 44 that extends rearwardly from the keypad 18 at a location centered between the openings 40.

The keypad assembly includes a conventional snap dome switch array 46 and a printed circuit board 48. The array of switches on the snap dome switch array are arranged in the same pattern as the pins 42 for keys 20. Likewise, the switch array includes switches arranged in the manner of the pins 32a-36a and pin 44. The printed circuit board 38 includes a plurality of switch contacts 56 which are actuated when the corresponding key 20 is depressed with the finger or thumb. The printed circuit board 48 also has four switch contacts 52 which are actuated individually when the corresponding arrow 32-38 is depressed with the thumb or finger. A switch contact 54 centered among contacts 52 is actuated when the enter key 24 is depressed. The construction and operation of the switches and contacts is conventional, and depression of the keys operates the electronics in a known manner.

In operation of the device 10, the cursor key 22 can be manipulated to position the on screen cursor icon at whatever location is desired. To move the cursor upwardly, the up arrow 32 is depressed with the thumb or finger. When arrow 34 is depressed, the cursor is moved downwardly. Movement of the cursor to the left is accomplished by depressing arrow 36, while rightward movement of the cursor is effected when the right arrow 38 is depressed. The enter key 24 can be depressed in order to enter whatever instructions or data have been selected prior to depression of the enter key 24. Normally, the thumb is used to depress the keys on the keypad. However, the fingers can also be used. Accordingly, the term “finger” is used herein to mean the thumb as well as fingers.

When the cursor key 22 has been manipulated to move the cursor to a desired location on the screen 16, the next operation is almost always depression of the enter key 24. Because the present invention locates the enter key 24 in the center of the cursor key 22, the enter key is situated where it can be quickly and conveniently depressed following manipulation of the cursor key 22. This facilitates the overall use of the device 10 and increases the speed with which the keypad 18 can be used.

Because the cursor key 22 is a conventional key rather than a joystick type device that only rocks or tilts, it is not subject to inadvertent actuation due to vibration or other outside influences. Because the cursor key 22 and the enter key 24 are incorporated together, a compact size is achieved, making the present invention particularly applicable to small communication and navigation devices. It will be understood, however, that the invention may be utilized in conjunction with other types of electronic terms, whether portable or not, such as personal digital assistants (PDAs), cellular telephones, panel mounted marine and avionics equipment, etc. on a personal computer or laptop computer keyboard. The enter key 24 can be made part of the keypad and constructed similarly to the other keys 20. There is no need for soldering operations or other special manufacturing procedures, so the overall cost is minimized. A conventional elastomeric keypad can be used, as can a conventional snap dome switch array and a standard printed circuit board to avoid the need for specially constructed parts. Finally, the device preferably has a rugged and weatherproof construction, particularly through the use of the elastomeric keypad 18 which makes the unit impervious to rain and other inclement weather conditions, although less rugged/weatherproof constructions may be made without departing from the invention.

Additionally, while the preferred embodiment is described as having a cursor key 22 (for scrolling) and an enter key 24, the actual functions associated with each key 22, 24 may vary depending upon the desired application.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

Having thus described the invention, what is claimed is:

1. In a keypad having a plurality of finger operated keys, the improvement comprising:
a cursor key having finger operated up and down areas thereon for up and down scrolling functions and left and right areas thereon for left and right scrolling functions; and
a finger operated enter key projecting through said cursor key and adapted for depression by a finger to carry out an enter function.

2. The improvement of claim 1, wherein:
said cursor key has a central opening located between said up and down areas and between said left and right areas; and
said enter key extends through said central opening.

3. The improvement of claim 2, wherein said cursor key is constructed in a manner to allow the cursor to move upwardly and downwardly independently of said enter key.

4. The improvement of claim 1, wherein said cursor key and enter key are located adjacent to a top center area of the keypad.

5. A keypad for a hand held electronic device, comprising:
a plurality of finger operated keys adapted for depression by a finger to effect selected functions;
a cursor key incorporated on said device rigidly in a manner to preclude rocking of said cursor key, said cursor key having finger operated up and down areas thereon for up and down scrolling functions and finger operated left and right areas thereon for left and right scrolling functions; and
a finger operated enter key projecting through said cursor key and adapted for depression by a finger to carry out an enter function of the device.

6. A keypad as set forth in claim 5, wherein:
said cursor key has a central opening located between said up and down areas and between said left and right areas; and
said enter key extends through said central opening.

7. A keypad as set forth in claim 5, wherein said cursor key and enter key are located adjacent to a top center area of the keypad.

8. A keypad as set forth in claim 5, including:
a printed circuit board having switch contacts; and
a snap dome switch array between said keys and said switch contacts.

9. A keypad as set forth in claim 8, wherein said keypad is elastomeric.

10. A hand held electronic device comprising:
a body presenting a front face having a visual display and a keypad having a plurality of finger operated keys;
a cursor key on said keypad having finger operated up and down areas thereon for scrolling up and down on the display and finger operated left and right areas thereon for scrolling left and right on the display;
a finger operated enter key incorporated with said cursor key on said keypad and adapted for depression by a finger to carry out an enter function.

11. A device as set forth in claim 10, wherein:
said cursor key has a central opening located between said up and down areas and between said left and right areas; and
said enter key extends through said central opening.

12. A device as set forth in claim 11, wherein said cursor key is mounted in such a manner to move independently of said enter key.

13. A device as set forth in claim 10, wherein said cursor key and enter key are located adjacent to a top center area of the keypad.

14. A device as set forth in claim 10, including:
a printed circuit board having switch contacts; and
a snap dome switch array between said keys and said switch contacts.

15. A device as set forth in claim 14, wherein said keypad is elastomeric.

16. A device as set forth in claim 10, including:
a printed circuit board having switch contacts; and
a snap dome switch array between said keys and said switch contacts.

17. A device as set forth in claim 16, wherein said keypad is elastomeric.

18. In a keypad having a plurality of finger operated keys, the improvement comprising:
a first key forming a ring and having a central opening, said first key having an associated first function; and
a second key positioned within said central opening of said first key, said second key constructed to operate independently of said first key and second key having an associated second function.
